(19) United States
(12) Patent Application Publication
(10) Pub. No.: US 2026/0036117 A1
(43) Pub. Date: Feb. 5, 2026

(54) CRYOGENIC AIR PROCESSING FOR A LIQUID AIR ENERGY CONVERSION SYSTEM

(71) Applicant: Henry E. Howard, Grand Island, NY (US)

(72) Inventor: Henry E. Howard, Grand Island, NY (US)

(21) Appl. No.: 19/092,254

(22) Filed: Mar. 27, 2025

Related U.S. Application Data
(60) Provisional application No. 63/678,164, filed on Aug. 1, 2024.

(51) Int. Cl. F03G 7/06; F01K 25/10; F17C 7/04

(52) U.S. Cl. CPC F03G 7/0641; F01K 25/10; F17C 7/04; F17C 2221/031; F17C 2223/0161; F17C 2223/035; F17C 2225/033; F17C 2227/0135; F17C 2227/0157; F17C 2227/0323; F17C 2265/06

(57) ABSTRACT

A liquid air energy conversion system is provided that recovers energy not by direct expansion of the liquid air stream, but rather by vaporization of the liquid air to form a first stream of very high pressure gaseous air via indirect heat exchange against a low pressure, cryogenic gas and subsequent sub-ambient or cold compression of the cooled, low pressure cryogenic gas to form a stream of moderate pressure gas. Both the stream of very high pressure gaseous air and the stream of moderate pressure gas are then warmed and expanded in one or more turbine expanders for production of shaft work and/or electrical energy.

### CROSS REFERENCE TO RELATED APPLICATIONS

This application claims the benefit of and priority to U.S. provisional patent application Ser. No. 63/678,164 filed on Aug. 1, 2024 the disclosure of which is incorporated by reference.

### TECHNICAL FIELD

The present invention relates generally to cryogenic air processing, and more particularly, to cryogenic air processing to improve the refrigeration recovery from liquid air and the integration with power generation sections of liquid air energy storage (LAES) systems.

BACKGROUND

There is a continuing need to develop and demonstrate new energy storage systems and technologies that are both technically feasible and commercially viable. Such energy storage systems and technologies should have the capacity to discharge energy for a duration of greater than 10 hours at rated power and at a levelized cost of storage of about $0.05/kWh-cycle at some point in the near future. The targeted energy storage systems should be at a mega-watt scale. Moreover, new energy storage systems and technologies should be long duration storage systems able to supply power for weekly or monthly durations and have the capacity to continuously discharge energy on a daily or diurnal cycle for between 10 hours to 100 hours or more.

Liquid air energy storage (LAES) is a known technology that is well suited for longer duration, and greater power generation magnitude than can be achieved economically with lithium-ion batteries. The liquefaction of ambient air can be accomplished at high efficiency with known gas turbo-expansion based equipment and processes. However, the effective extraction of the energy contained or stored within the liquid air is a far more difficult challenge. Roughly 50% of the energy contained within liquid air is contained in the cryogenic, sub-ambient state. Conventional approaches to extraction and recovery of this energy from liquid air involve periodic heat exchange with cold stores (i.e. solids and liquids of high thermal capacitance) as generally disclosed in United States Patent Application Publications US2017/0022897 and US2023/0408188.

The cost and complexity of conventional LAES systems, including those that employ the use of cold stores, is relatively high and thus a barrier to widespread adoption and use in the long duration energy storage market. Unlike most other energy storage technologies, LAES based systems often require mostly discrete and separate equipment for the charging step and the generating step, which represents a fundamental problem. To realize widespread adoption of LAES based systems, there must be a significant cost reduction of the LAES equipment and preferably a step in the efficiency of energy extraction/recovery from liquid air. In particular, there is a need to improve the refrigeration recovery from liquid air and the integration with subsequent power generation.

### SUMMARY

The present liquid air energy conversion system may be broadly characterized as a liquid air energy conversion system comprising: (a) a source of liquid air; (b) a source of clean, dry, low pressure cryogenic gas; (c) one or more pumps configured to pump the liquid air to a supercritical pressure; (d) one or more heat exchangers configured to vaporize the supercritical liquid air via indirect heat exchange against a stream of the clean, dry, low pressure cryogenic gas to form a stream of very high pressure gaseous air and a stream of cooled, low pressure cryogenic gas; and (e) one or more compressors, including at least one cold compressor, configured to compress the stream of cooled, low pressure cryogenic gas, to form a stream of moderate pressure gas. All or a portion of the moderate pressure gas is directed to the heat exchanger and wherein the heat exchanger is further configured to warm the moderate pressure gas via indirect heat exchange against the stream of the clean, dry, low pressure cryogenic gas. The warming of the moderate pressure gas enables the thermal balancing the warm end of the one or more heat exchangers.

In some embodiments, the stream of very high pressure gaseous air and the stream of moderate pressure gas are then warmed via indirect heat exchange with waste heat from a gas turbine cycle or other purposeful heating source. The liquid air energy conversion system also may comprise one or more expansion turbines configured to expand the warmed stream of very high pressure gaseous air and/or the warmed stream of moderate pressure gas and convert the work of expansion into power.

The invention may also be characterized as a method of extracting energy in a liquid air energy storage system comprising the steps of: (i) providing a source of liquid air from the liquid air energy storage system; (ii) providing a source of clean, dry, low pressure cryogenic gas; (iii) pumping the liquid air to a supercritical pressure; (iv) vaporizing the supercritical liquid air via indirect heat exchange against a stream of the clean, dry, low pressure cryogenic gas to form at least one stream of very high pressure gaseous air and a stream of cooled, low pressure cryogenic gas; (v) compressing the stream of cooled, low pressure cryogenic gas in one or more compressors, including at least one cold compressor to form a stream of moderate pressure gas; (vi) warming all of or a portion of the one or more streams of very high pressure gaseous air and the stream of moderate pressure gas; and (vii) expanding the warmed one or more streams of very high pressure gaseous air and the warmed stream of moderate pressure gas to yield a work of expansion and converting the work of expansion into power.

In preferred embodiments, the present liquid air energy conversion system and associated method extracting energy further utilizes one or more mechanical pumps configured in a serial or parallel orientation to pump the liquid air to a pressure in excess of about 100 bar (a) prior to delivery to the heat exchanger where the supercritical liquid air is warmed and vaporized. The stream of the clean, dry, low pressure cryogenic gas is composed of air constituents preferably at a pressure in the range of about 3 bar(a) to about 10 bar(a) as it enters the heat exchanger. Upon exit from the cold end of the heat exchanger, preferably at a point of near-saturation, the stream of cooled, low pressure cryogenic gas is first directed to the cold compressor where it is compressed to a pressure in the range of about 10 bar(a) to about 50 bar(a) and then to auxiliary compressors where the cold compressed gas stream may be further compressed to form the stream of moderate pressure gas.

In one embodiment of the present liquid air energy conversion system and associated method of extracting energy, a first portion of the cold compressed gas stream, preferably in the range of 20% to 50% by volume, is warmed in the heat exchanger via indirect heat exchange against the stream of the low pressure cryogenic gas and may then be further compressed in a first auxiliary compressor to produce a first high pressure discharge stream. A second or remaining portion of the cold compressed gas stream is directed to a second auxiliary compressor to produce a second high pressure discharge stream. The first high pressure discharge stream and the second high pressure discharge stream are then combined to form the stream of moderate pressure gas.

In an alternate embodiment of the present liquid air energy conversion system and method of extracting energy, the warmed first portion of the cold compressed gas stream is directly combined with the second portion of the cold compressed gas stream and directed to a single auxiliary compressor to produce a discharge stream that forms the stream of moderate pressure gas.

### BRIEF DESCRIPTION OF THE DRAWINGS

The above and other aspects, features, and advantages of certain embodiments of the present disclosure will be more apparent from the following detailed description taken in conjunction with the following drawing in which:

FIG. 1 is an illustration of a part of the liquid air energy conversion system in accordance with an embodiment of the present system and method depicted as a section of a liquid air energy storage (LAES) system; and

FIGS. 2-7 are illustrations of a part of the liquid air energy conversion system in accordance with other embodiments of the present system and method.

### DETAILED DESCRIPTION

As used herein, the term or phrase ‘low pressure’ means a pressure near ambient, and more particularly at a pressure of 10 bar(a) or less whereas the term or phrase ‘moderate pressure’ refers to a pressure that might exist at the gas turbine inlet in a conventional gas turbine based power recovery section of the liquid air energy conversion system, and more particularly a pressure between 10 bar(a) to about 50 bar(a). Likewise, the term or phrase ‘very high pressure’ refers to a pressure where the fluid is substantially supercritical, and in the case of liquid air energy conversion, preferably to a pressure of greater than 75 bar(a).

From a definition standpoint the term or phrase ‘air’ and ‘air stream’ should be construed to mean an oxygen and nitrogen containing stream that has an oxygen concentration not less than 10%. However, the term or phrase ‘liquid air’ should be understood to include cryogenic liquids having a nitrogen content greater than or equal to 70%, so as to include liquified air as well as liquid nitrogen. Also, the term or phrase ‘cryogenic gas’ being defined to mean a gas possessing a boiling point less than −150° C. or more broadly as a gas that would not condense as it is cooled by the warming supercritical air.

The present system and method provides part of an alternative energy conversion solution that is a variation of conventional LAES systems. In the present system and method the extraction of the energy is achieved not solely by expansion of the liquid air stream, but rather by: (i) vaporization of the liquid air at a supercritical pressure to form a stream of very high pressure gaseous air via indirect heat exchange against a low pressure pre-purified stream of cryogenic gas; (ii) sub-ambient compression of the cooled low pressure pre-purified stream of cryogenic gas to form a stream of moderate pressure gas; and (iii) expansion of both the stream of very high pressure gaseous air and the moderate pressure gas in one or more turbine expanders for energy recovery.

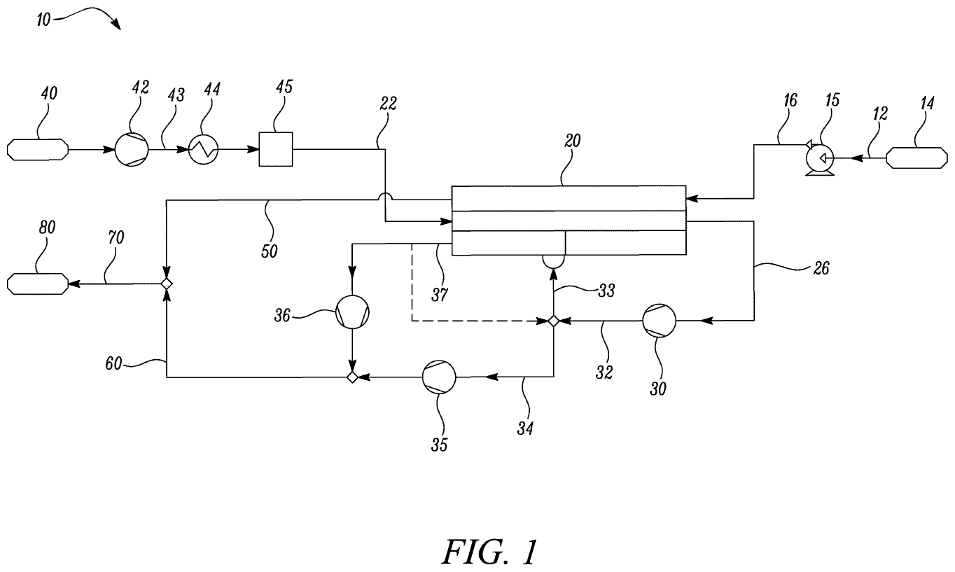

Turning now to FIG. 1, the present solution is a liquid air energy conversion system 10 depicted in the illustrated section of the LAES system which requires a heat exchanger 20 and a cold compressor 30 collectively configured for warming/vaporization of a source of liquid air (preferably pumped to a supercritical pressure) via indirect heat exchange against a stream of clean, dry, low pressure cryogenic gas (preferably a low pressure, pre-purified stream of gaseous air) and the subsequent sub-ambient compression or cold compression of the cooled, low pressure cryogenic gas.

In the preferred embodiment, a liquid air stream 12 is pumped from a low pressure storage tank 14 via pump 15 to a supercritical pressure preferably in excess of 100 bar(a). Although only one pump is illustrated in the embodiments, it is fully understood that one or more pumps may be used. Moreover, the one or more pumps may be disposed in a serial arrangement, a parallel arrangement or a combination of serial and parallel arrangements. The pumped liquid air stream 16 is then vaporized in heat exchanger 20 by indirect heat exchange against a stream of low pressure, pre-purified air 22 to yield a stream of very high pressure supercritical air and a cooled, low pressure, pre-purified stream of gaseous air 26.

The stream of low pressure, pre-purified gaseous air 22 is preferably at a pressure in the range of 3 bar(a) to 10 bar(a) and may be provided from a nearby air separation plant (not shown), or the power recovery section 80 of the liquid air energy conversion system, or it may be produced on-demand as illustrated in FIG. 1 by compressing a source of ambient air 40 in a compressor 42, removing the heat of compression and any condensate from the compressed air stream 43 in an aftercooler 44, and removing water, carbon dioxide and optionally other contaminants in an adsorption based pre-purification unit 45 to yield the stream of low pressure, pre-purified air.

The cooled, low pressure, pre-purified stream of gaseous air 26 exiting the cold end of the heat exchanger 20 is preferably at or near saturation and is then directed to a cold compressor 30 (which may be comprised of several compression stages) where it is further compressed to a pressure preferably in the range of 15 bar(a) to 50 bar(a). Such sub-ambient or cold compression results in a superheated gas that is still of sub-ambient temperature referred to as the cold compressed gaseous air stream 32. A first portion 33 of this cold compressed gaseous air stream, preferably in the range of about 20% to 50% by volume, is directed back into an intermediate location of the heat exchanger 20 where it is further warmed against the low pressure, pre-purified stream of gaseous air 22 and exits the warm end of the heat exchanger 20. The warming of a portion of the cold compressed gaseous air stream enables the thermal balancing the warm end of heat exchanger 20. Although not shown, alternate means of thermal balancing using other cooling streams may also be employed.

A second portion 34 or the remaining portion of this cold compressed gaseous air stream is further compressed in an auxiliary compressor 35 (which also may be comprised of several compression stages) to a pressure suitable for use in the energy recovery section 80 of the liquid air energy conversion system for power generation and/or energy recovery purposes. Alternatively, the further compressed air, if at sufficiently high pressure, may be combined with the stream of very high pressure air.

Similarly, the warmed first portion 37 of this cold compressed gaseous air stream may be further compressed separately in yet another auxiliary compressor 36. Alternatively, the warmed first portion 37 of the cold compressed gaseous air stream may be re-combined with the second portion 34 of the cold compressed gaseous air stream directed to compressor 35. The further compressed and re-combined first portion and second portion of the cold compressed gaseous air stream forms a stream of moderate pressure gas 60. If feasible, the stream of very high pressure gaseous air 50 and the stream of moderate pressure gas 60 are combined to form a single pressurized gaseous air stream 70. Alternatively, the stream of very high pressure gaseous air 50 and the stream of moderate pressure gas 60 may be directed separately to the energy recovery section 80 of the liquid air energy conversion system for power generation and/or energy recovery purposes.

Although not shown, the pressurized gaseous air stream 70, the stream of very high pressure gaseous air 50 and/or the stream of moderate pressure gas 60 are preferably directed to at least one stage of power expansion and more preferably a plurality of stages of power expansion in an energy recovery section 80 of the liquid air energy conversion system for power generation and/or energy recovery purposes. For example, the pressurized gaseous air stream 70, the stream of very high pressure gaseous air 50 and/or the stream of moderate pressure gas 60 would be initially warmed via indirect heat exchange with waste heat from a gas turbine power cycle (not shown) and then power expanded to a pressure suitable for introduction into the gas turbine.

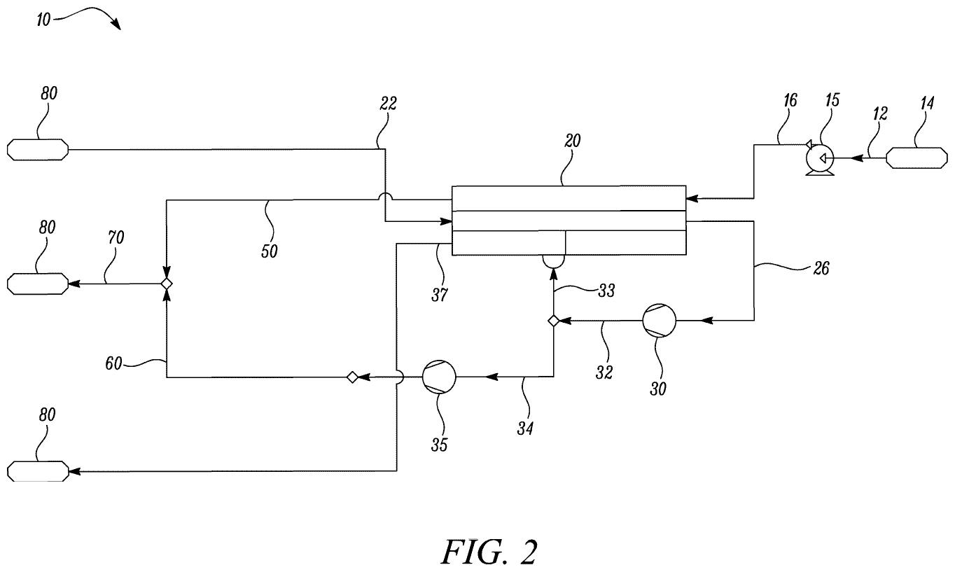

Turning to FIG. 2, there is shown a schematic of another embodiment of the cryogenic air processing portion part of the liquid air energy conversion system. Many of the features, components and streams associated with the cryogenic air processing portion part of the liquid air energy conversion system shown in FIG. 2 are similar or identical to those described above with reference to the embodiment of FIG. 1 and for sake of brevity will not be repeated here. The key differences between the system shown in FIG. 2 compared to the embodiment described above with particular reference to FIG. 1, is the stream of low pressure, pre-purified gaseous air 22 is preferably received from the power recovery section 80 of the liquid air energy conversion system in lieu of the stand- alone compressor, aftercooler, and pre-purification unit shown in FIG. 1.

Another key difference between the embodiment of FIG. 2 and the previously discussed embodiment of FIG. 1 is the warmed first portion 37 of the cold compressed gaseous air stream exiting the warm end of the heat exchanger 20 is directly sent to the power recovery section 80 of the liquid air energy conversion system (and without further compression) as another moderate pressure gaseous air stream. In this embodiment, there is no re-combining the warmed first portion 37 of the cold compressed gaseous air stream with the second portion of the cold compressed gaseous air stream.

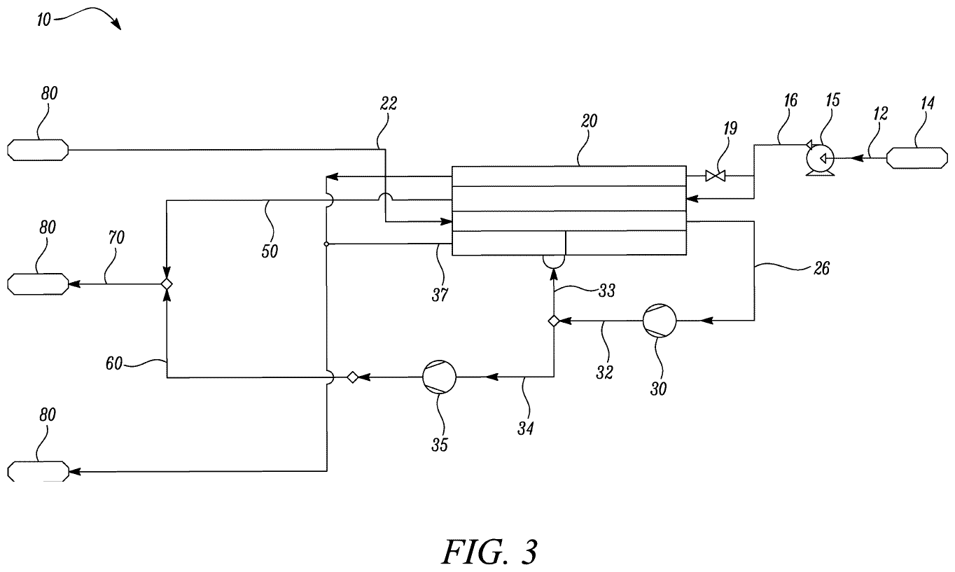

Turning to FIG. 3, there is shown a schematic of yet another embodiment of the cryogenic air processing portion part of the liquid air energy conversion system. Many of the features, components and streams associated with the cryogenic air processing portion part of the liquid air energy conversion system shown in FIG. 3 are similar or identical to those described above with reference to the embodiments of FIGS. 1 and 2, for sake of brevity will not be repeated here. The key differences between the system shown in FIG. 3 compared to the system described above with particular reference to FIG. 2, is the diversion of a portion of the very high pressure liquid air stream 16. This diverted stream is reduced in pressure by expansion valve 19 and introduced into another warming heat exchanger passage where the lower pressure liquid air is also vaporized against the low pressure air stream 22. This dual warming of the liquid air streams aids the refrigeration recovery and the performance of heat exchanger at the cold end by more closely matching the composite cooling and warming curves.

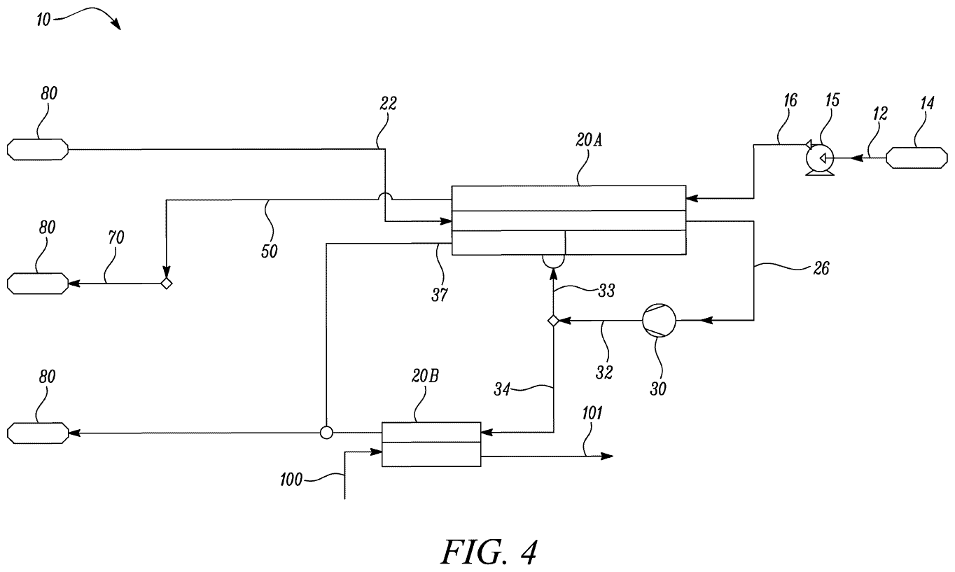

Turning to FIG. 4, there is shown a schematic of still another embodiment of the cryogenic air processing portion part of the liquid air energy conversion system. As many of the features, components and streams associated with the cryogenic air processing portion part of the liquid air energy conversion system shown in FIG. 4 are similar or identical to those described above with reference to the embodiments of FIGS. 1 and 2, for sake of brevity discussion of such features and elements will not be repeated here.

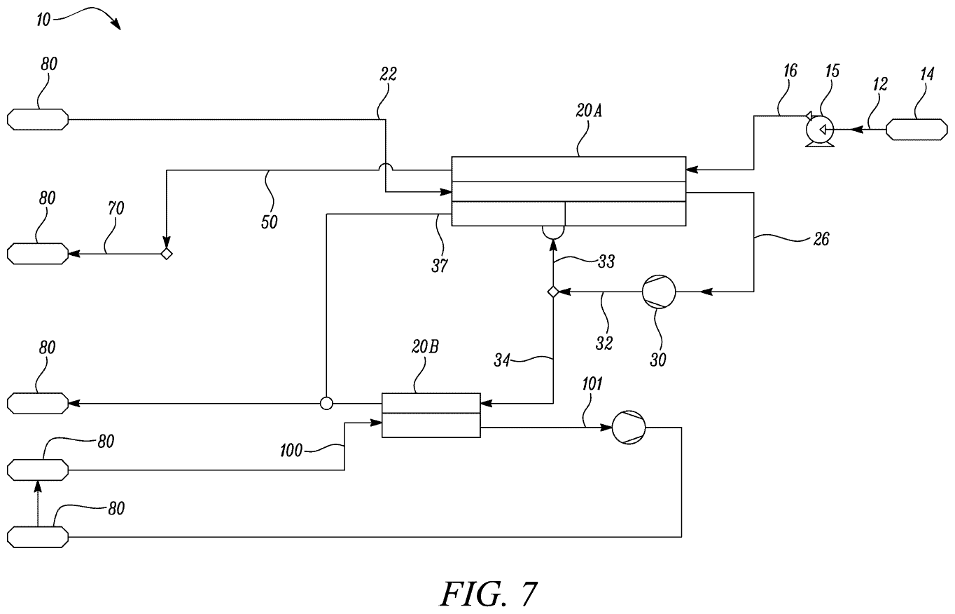

The key differences between the system shown in FIG. 4 compared to the system described with reference to FIG. 2, is the second portion 34 of the cold compressed gaseous air stream is not further compressed in an auxiliary compressor 35 and not combined with the very high pressure gaseous air stream 50. Rather, the second portion 34 of the cold compressed gaseous air stream is directed to an auxiliary heat exchanger 20B. Because the second portion 34 of the cold compressed gaseous air stream is still appreciably cold, additional refrigeration may be recovered by cooling a brine or glycol or other heat transfer fluid 100 via indirect heat exchange with the second portion 34 of the cold compressed gaseous air stream in auxiliary heat exchanger 20B to yield a cooled heat transfer fluid 101. The resulting warmed, moderate pressure, cold compressed gaseous air stream is re-combined with the warmed 37 warmed first portion 37 of the cold compressed gaseous air stream exiting the warm end of the heat exchanger 20A. The combined moderate pressure air stream 60 is then directed to the power recovery section 80 of the liquid air energy conversion system separately from the very high pressure gaseous air stream 50. The cooled heat transfer fluid may be used to cool water or may be used for other cooling purposes in the present system, cooling the incoming air feed in the gas turbine cycle section of the liquid air energy conversion system, or elsewhere at the facility. The heat transfer fluid may even be another gas, with such gas being cooled against stream 34 (See e.g., FIG. 7). In such embodiment, the cooled gas 101 may also be directed to another cold compressor and substantially pressurized in a closed loop or pseudo closed loop refrigeration system. In the embodiment illustrated in FIG. 7, the resulting pressurized stream 101 may also be employed for additional shaft work and/or power generation in LAES system 80.

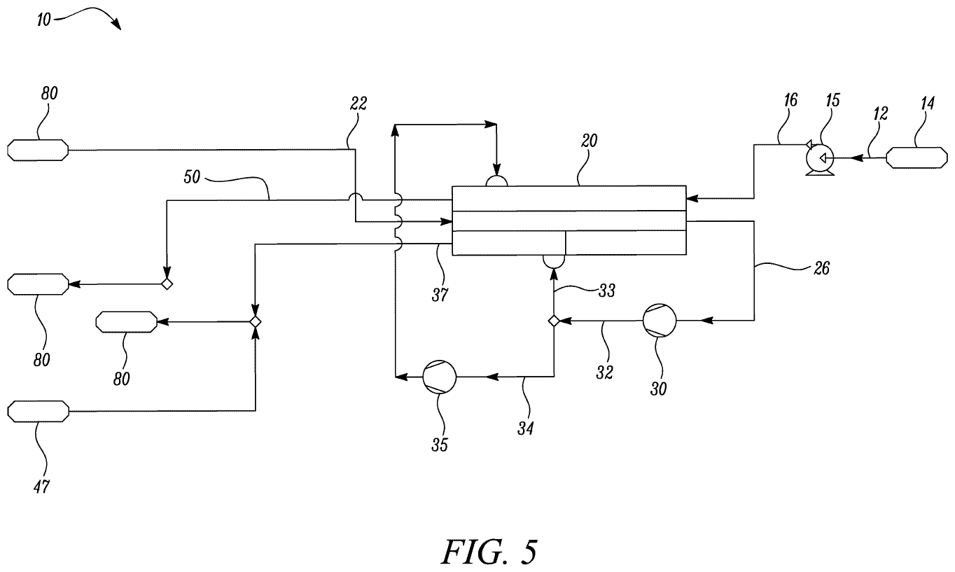

Turning to FIG. 5, there is shown a schematic of a further embodiment of the cryogenic air processing portion part of the liquid air energy conversion system. Again, as many of the features, components and streams associated with the cryogenic air processing portion part of the liquid air energy conversion system shown in FIG. 5 are similar or identical to those described above with reference to the embodiments of FIGS. 1-4, for sake of brevity, discussion of such features and elements will not be repeated here.

The key differences between the system shown in FIG. 5 compared to the system described with reference to the other above-described embodiments is that the second portion 34 of the cold compressed gaseous air stream is further compressed to high or very high pressures in auxiliary compressor 35 and then mixed with the very high pressure gaseous air stream within the main heat exchanger 20. Specifically, the further compressed second portion is directed to an intermediate location near the warm end of the main heat exchanger 20 where the very high pressure stream is being warmed or vaporized.

In this and other embodiments, the main heat exchanger is preferably a brazed aluminum heat exchanger (BAHX). Use of a BAHX allows recuperation of the additional refrigeration from the further compressed second portion of the cold compressed gaseous air stream. Please note that it is to be understood that while the illustrated embodiments show just one main heat exchanger, the respective services of the BAHX can be segregated into separate BAHX exchangers and/or separate heating or cooling passages within the single BAHX core.

Another difference in the embodiment illustrated in FIG. 5 is the addition of water to hydrate or re-hydrate a moderate pressure air stream using a source of water 47. In the illustrated embodiment, the moderate pressure air stream to be hydrated is the first warmed portion 37 of the cold compressed gaseous air stream directed to the power recovery section 80 of the liquid air energy conversion system, although the idea of hydrating the moderate pressure air stream can be applied to other streams directed to the power recovery section 80 of the liquid air energy conversion system.

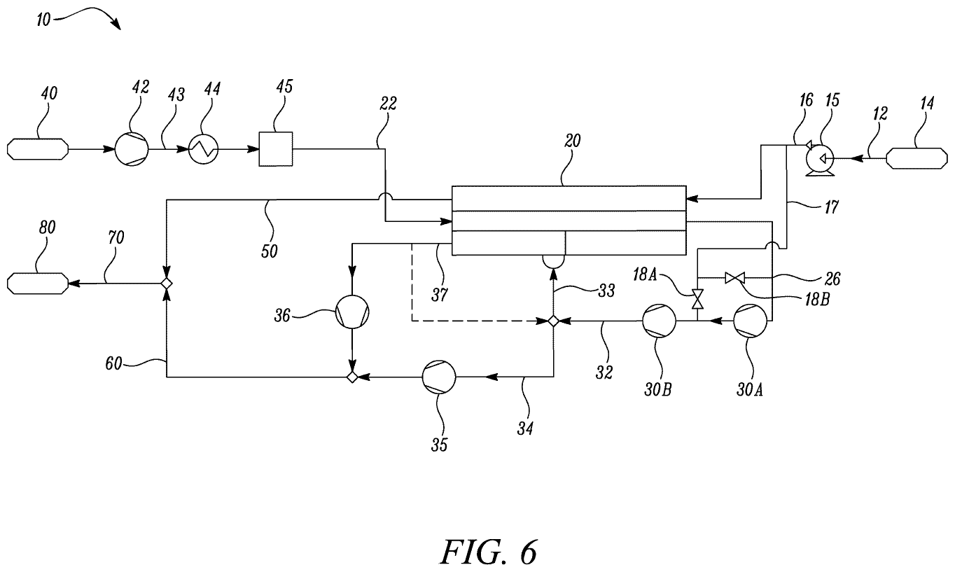

Turning to FIG. 6, there is shown a schematic of another embodiment of the cryogenic air processing portion part of the liquid air energy conversion system illustrating the concept of using a portion of the liquid air for direct contact cooling of the cooled, low pressure, pre-purified stream of gaseous air 26 and/or the moderate pressure, cold compressed air streams. Again, as many of the features, components and streams associated with the cryogenic air processing portion part of the liquid air energy conversion system shown in FIG. 6 are similar or identical to those described above with reference to the embodiment of FIG. 1, for sake of brevity, discussion of such previously disclosed features and elements will not be repeated here.

The key differences between the embodiment shown in FIG. 6 compared to the embodiment of FIG. 1 is that a portion 17 of the supercritical liquid air is diverted and added via valve 18B to the cooled, low pressure, pre-purified stream of gaseous air 26 and/or via valve 18A to the moderate pressure, cold compressed air streams downstream of the first cold compressor 30A. Note, as illustrated, the cold compression of the cooled, low pressure cryogenic gas (e.g., the cooled, low pressure, pre-purified stream of gaseous air 26) may occur in multiple compression stages (e.g., compressors 30A, 30B, etc.) Such multi-stage cold compression and direct contact cooling using a diverted portion of the liquid air can be incorporated into any of the above-described embodiments. Although not shown, the introduction of liquid air (18A, 18B) may be affected by way of additional control means or the inclusion of phase separation vessels. Such vessels would ensure that liquid is not aspirated into compression stages 30A and 30B.

While the present system and method has been described with reference to certain embodiments, various changes may be made without departing from the spirit and the scope of the disclosure, which is defined, not by the detailed description and embodiments, but by the appended claims and their equivalents.

What is claimed is:

1. A liquid air energy conversion system comprising:
a source of liquid air;
a source of clean, dry, low pressure cryogenic gas having a normal boiling point of −150° C. or lower;
one or more pumps configured to pump the liquid air to a supercritical pressure;
one or more heat exchangers configured to vaporize the supercritical liquid air via indirect heat exchange against a stream of the clean, dry, low pressure cryogenic gas to form a stream of very high pressure gaseous air and a stream of cooled, low pressure cryogenic gas; and
one or more compressors, including at least one cold compressor, configured to compress the stream of cooled, low pressure cryogenic gas, to form a stream of moderate pressure gas;
wherein at least a portion of the very high pressure gaseous air and the moderate pressure gas are utilized to produce electrical power.

2. The liquid air energy conversion system of claim 1, further comprising a refrigerant stream introduced into the one or more heat exchangers and wherein the one or more heat exchangers are further configured to warm the refrigerant stream via indirect heat exchange against the stream of the clean, dry, low pressure cryogenic gas to thermally balance the warm end of the one or more heat exchangers.

3. The liquid air energy conversion system of claim 2, wherein the refrigerant stream is a portion of the cooled, low pressure cryogenic gas.

4. The liquid air energy conversion system of claim 1, wherein the stream of very high pressure gaseous air and the stream of moderate pressure gas are warmed via indirect heat exchange with waste heat from a gas turbine cycle and the liquid air energy conversion system further comprises one or more expansion turbines configured to expand the warmed stream of very high pressure gaseous air and the warmed stream of moderate pressure gas and convert the work of expansion into power.

5. The liquid air energy conversion system of claim 1, wherein the stream of cooled, low pressure cryogenic gas exiting the one or more heat exchangers is directed to the cold compressor where it is compressed to form a cold compressed gas stream, and the liquid air energy conversion system further comprises one or more auxiliary compressors configured to further compress the cold compressed gas stream to form the stream of moderate pressure gas.

6. The liquid air energy conversion system of claim 5, wherein a first portion of the cold compressed gas stream is directed to the one or more heat exchangers and wherein the one or more heat exchangers are further configured to warm the first portion of the cold compressed gas stream via indirect heat exchange against the stream of the clean, dry, low pressure cryogenic gas.

7. The liquid air energy conversion system of claim 6, wherein the first portion of the cold compressed gas stream is in the range of 20% to 50% by volume of the cold compressed gas stream.

8. The liquid air energy conversion system of claim 6, wherein the warmed first portion of the cold compressed gas stream is directed to a first auxiliary compressor configured to further compress the warmed first portion of the cold compressed gas stream and produce a first discharge stream.

9. The liquid air energy conversion system of claim 8, wherein a second portion of the cold compressed gas stream is directed to a second auxiliary compressor configured to further compress the second portion of the cold compressed gas stream and produce a second discharge stream.

10. The liquid air energy conversion system of claim 9, wherein the first discharge stream and the second discharge stream are combined

11. The liquid air energy conversion system of claim 6, wherein the warmed first portion of the cold compressed gas stream is combined with a second portion of the cold compressed gas stream and directed to an auxiliary compressor configured to further compress the combined stream and produce a discharge stream that forms the stream of moderate pressure gas.

12. The liquid air energy conversion system of claim 1, further comprising one or more pumps configured to pump the liquid air to a supercritical pressure in excess of 75 bar(a).

13. The liquid air energy conversion system of claim 12, wherein the one or more pumps are disposed in a serial arrangement.

14. The liquid air energy conversion system of claim 12, wherein some of the one or more pumps are disposed in a parallel arrangement.

15. The liquid air energy conversion system of claim 14, wherein the cryogenic gas is comprised of one or more constituents of air.

16. The liquid air energy conversion system of claim 1, wherein the clean, dry, low pressure cryogenic gas is a pre-purified air stream at a pressure in the range of 3 bar(a) to 10 bar(a).

17. A method of extracting energy in a liquid air energy storage system comprising the steps of:
(i) providing a source of liquid air from the liquid air energy storage system;
(ii) providing a source of clean, dry, low pressure cryogenic gas having a normal boiling point of −150° C. or lower;
(iii) pumping the liquid air to a supercritical pressure;
(iv) vaporizing the supercritical liquid air via indirect heat exchange against a stream of the clean, dry, low pressure cryogenic gas to form at least one stream of very high pressure gaseous air and a stream of cooled, low pressure cryogenic gas;
(v) compressing the stream of cooled, low pressure cryogenic gas in one or more compressors, including at least one cold compressor to form a stream of moderate pressure gas;
(vi) warming the one or more streams of very high pressure gaseous air and the stream of moderate pressure gas; and
(vii) expanding the warmed one or more streams of very high pressure gaseous air and the warmed stream of moderate pressure gas to yield a work of expansion and converting the work of expansion into power.

18. The method of claim 17, wherein the step of warming the one or more streams of very high pressure gaseous air and the stream of moderate pressure gas further comprises warming the one or more streams of very high pressure gaseous air and the stream of moderate pressure gas via indirect heat exchange with waste heat from a gas turbine cycle.

19. The method of claim 17, wherein the cryogenic gas is comprised of one or more constituents of air.

20. The method of claim 17, wherein the clean, dry, low pressure cryogenic gas air further comprises a stream of low pressure, pre-purified gaseous air at a pressure in the range of 3 bar(a) to 10 bar(a).

21. The method of claim 17, wherein the step of compressing the stream of cooled, low pressure cryogenic gas in one or more compressors further comprises:
compressing the cooled, low pressure cryogenic gas in the cold compressor to form a cold compressed gas stream;
warming a first portion of the cold compressed gas stream via indirect heat exchange against the stream of the clean, dry, low pressure cryogenic gas; and
further compressing the warmed first portion of the cold compressed gas stream and a second portion of the cold compressed gas stream in one or more auxiliary compressors to form the stream of moderate pressure gas.

22. The method of claim 19, wherein the first portion of the cold compressed gas stream is in the range of 20% to 50% by volume of the cold compressed gas stream.
